(19) United States
(12) Patent Application Publication
(10) Pub. No.: US 2015/0139461 A1
(43) Pub. Date: May 21, 2015

(54) ENHANCED HEARING AID

(71) Applicant: TriXcel, LLP, Newbury, MA (US)

(72) Inventors: Berj TERZIAN, NEWBURY, MA (US); Jack EKCHIAN, BELMONT, MA (US)

(73) Assignee: TriXcel, LLP, Newbury, MA (US)

(21) Appl. No.: 14/086,342

(22) Filed: Nov. 21, 2013

(51) Int. Cl. H04R 25/00

(52) U.S. Cl. CPC H04R 25/654
USPC 381/328

(57) ABSTRACT

Hearing aids are enhanced by application of liquids thereto, said liquids being solvents for organic matter, or wax, or ear canal wax. The liquids are volatile. Application of the liquids to both the hearing dome ends and the ear canal surfaces create a coupling thereof, which maintains a desired position of the aids within the ear canals.

### FIELD OF THE INVENTION

This invention relates to hearing aids and enhancement thereof in a novel manner.

### PRIOR ART

Hearing aids generally are composed of three components (a) a small rigid shell shaped like a banana, (b) a thin plastic flexible tube extending outwardly from one end of the shell, and (c) a plastic perforated dome at the other end of the tube.

FIG. 1 is a schematic of such an aid, having shell 10, thin tube 12 and dome 14.

The shell contains microelectronic circuits which generate electrical or electronic sine waves that pass through the thin plastic tube. At the dome end, the waves vibrate a tympanic-disc that stimulates natural hearing bones, thereby amplifying sound to the wearer's ears. Some aids include a conductive wire within the thin tube at the dome end.

### PROBLEMS

During sleep temperature in human ears is approximately 98° F. After awakening, humidity can cause condensation in the ear canals. This can cause ear wax to form in the canals which is undesirable and can cause problems with the hearing aid's ability to properly function.

### SUMMARY OF THE INVENTION

A simple method has been determined which can ameliorate these problems. In particular, certain liquids, organic chemicals, can be applied upon the dome ends of the flexible tube. This can be supplemented, as well, by washing the ear canal with the liquids. These actions form a coupling between the ear canal surface and the domes, which maintain desired positions of the aids at least throughout a day.

### BRIEF DESCRIPTION OF THE DRAWING

FIG. 1 illustrates a conventional hearing aid.

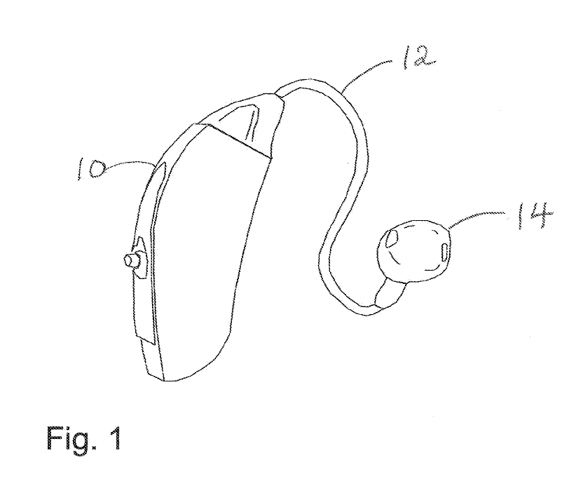

### DETAILED DESCRIPTION OF THE INVENTION

Examples of the liquids are methanol, ethanol, propanol, butenol-1 acetone, and the like. These organic liquids are volatile solvents for organic materials, such as wax, ear wax, and other organic compositions. They are ideal for suppressing ear wax and other foreign materials in ear canals.

Hearing aid users can fill small containers of the liquids and maintain the contents for use throughout the day and at different locations. Users can wet their index-fingers and can easily apply the liquids to the dome ends several times, preferably 4 or 5 times in one day. Similar multiple applications are also preferable in their ear canals in one day.

The invention has been described with multiple components and embodiments. Variations can be made by those skilled in the art. It should be understood that all such variations are within the scope of the invention as well as the following claims.

The following is claimed:

1. A method of enhancing use of hearing aids by applying liquids to the dome ends thereof, said liquids being solvents for organic matter.

2. The method of claim 1, wherein the liquids are solvents for wax.

3. The method of claim 1, wherein the liquids are solvents for ear canal wax.

4. The method of claim 1, wherein the liquids are volatile.

5. An enhanced hearing aid having liquids applied to its dome ends, said liquids being solvents for organic matter.

6. The enhanced hearing aid of claim 5, wherein the liquids are solvents for wax.

7. The enhanced hearing aid of claim 6, wherein the liquids are solvents for ear canal wax.

8. An enhanced hearing aid having organic liquids applied to both an user's ear canals and dome ends.

9. The enhanced hearing aid of claim 9, wherein the liquids are solvents for organic matter.

10. The enhanced hearing aid of claim 9, wherein the solvent is volatile.
